(19) United States
(12) Patent Application Publication
(10) Pub. No.: US 2016/0071213 A1
(43) Pub. Date: Mar. 10, 2016

(54) Factor-Factor Covariance Estimates for Risk Factor Groups in Factor Risk Models

(71) Applicant: Anthony A. Renshaw, New York, NY (US)

(72) Inventor: Anthony A. Renshaw, New York, NY (US)

(73) Assignee: AXIOMA, INC., New York, NY (US)

(21) Appl. No.: 14/482,685

(22) Filed: Sep. 10, 2014

(51) Int. Cl. G06Q 40/06

(52) U.S. Cl. CPC G06Q 40/06

(57) ABSTRACT

Tools for analyzing the risk of a portfolio of financial investments such as equities, bonds, and the like, are addressed. More particularly, computer based systems, processes and software are addressed for calculating factor risk models and for predicting the risk and tracking error of portfolios. A particular approach that can be utilized to revise the factor-factor covariance estimates of a factor risk model is provided. This approach is applied to factor risk model predictions, portfolio construction using the factor risk model, and performance attribution using the factor risk model.

### FIELD OF INVENTION

The present invention relates generally to improved methods and tools for analyzing the risk of a portfolio of financial investments such as equities, bonds, and the like. More particularly, the invention relates to improved computer based systems, methods and software for calculating factor risk models that predict the risk and tracking error of portfolios. The present invention describes a particular approach that can be utilized to improve the factor-factor covariance estimates of a factor risk model. This advantageous approach improves the factor risk model predictions, portfolios constructed using the factor risk model, and performance attribution using the factor risk model.

### BACKGROUND OF THE INVENTION

Factor risk models have been used to predict the risk and tracking error of portfolios for over three decades. The goal of a factor risk model is to predict the asset volatility and asset-asset correlation for every asset and every asset pair, respectively, in a universe of potential investments such as equities, bonds, and the like. For a universe with N possible investments, the predicted volatilities and correlations are described mathematically by an N by N asset-asset covariance matrix, herein denoted as Q. If the portfolio holdings or weights are described by the N dimensional column vector w, then the risk of that portfolio is given by the mathematical formula

σ=\sqrt{w^{T}Qw} (1)

where σ is the risk and the superscript T indicates transposition. If the weights of a reference benchmark of investments are denoted by the N dimensional column vector w_{b}, then the tracking error or active risk of the portfolio relative to that benchmark is given mathematically by

TE=\sqrt{(w−w_{b})^{T}Q(w−w_{b})} (2)

where TE indicates tracking error. Risk and tracking error can be measured in units such as percent daily, percent monthly, or percent annual volatility.

A good estimate of Q is useful not only for estimating the risk of a known portfolio but can also be used effectively to construct new portfolios that prescribe a trade-off between the potential return and risk of the portfolio. The potential return of the portfolio is normally specified with a column vector of expected returns or “alphas” for each asset in the investment universe. This approach to portfolio construction is termed mean-variance portfolio optimization and was first described by H. Markowitz, “Portfolio Selection”, Journal of Finance 7(1), pp. 77-91, 1952 which is incorporated by reference herein in its entirety.

In mean-variance optimization, a portfolio is constructed that minimizes the risk of the portfolio while achieving a minimum acceptable level of return. Alternatively, the level of return is maximized subject to a maximum allowable portfolio risk. The family of portfolio solutions solving these optimization problems for different values of either minimum acceptable return or maximum allowable risk is said to form an “efficient frontier”, which is often depicted graphically on a plot of risk versus return. There are numerous, well known, variations of mean-variance portfolio optimization that are used for portfolio construction. These variations include methods based on utility functions (in which the utility is defined as a linear combination of the expected return and predicted variance of the portfolio returns, which is the square of the predicted risk), Sharpe ratio (the ratio of annual expected return over the predicted annual risk), and value-at-risk. Axioma, Inc. sells a commercial software product called Axioma Portfolio™ specifically designed to optimally construct a portfolio given various objectives and constraints on the final portfolio holdings. The objectives and constraints can entail combinations of return, risk, variance, tilts on scores, exposures to industries, sectors, countries, and currencies, transaction costs, and market impact functions. As particular examples, an objective may be maximize the sum of the expected return (or alpha) minus the transaction costs, minus the cost of shorting, minus ticket charges, minus market impact, minus the predicted variance or risk of the portfolio. Each of these terms would have a weighting constant in front of them in the objective function, and the weighting constants would be calibrated by, say, backtests. Example constraints would include limiting the maximum sector exposure to plus or minus 10% of the benchmark sector exposures, limiting turnover to 20%, or limiting the maximum asset holding to 5%. A novel approach to portfolio construction using factor risk models is described in U.S. Pat. Nos. 7,698,202 and 8,315,936, which are incorporated by reference herein in their entirety.

To be sure, there are other approaches that have been used to estimate the risk of a portfolio of financial assets. These methods include GARCH approaches and Monte-Carlo simulation using historical returns. See, for example, P. Benson and P. Zangari, “A General Approach to Calculating VaR Without Volatilities and Correlations,” RiskMetrics™ Monitor, Second Quarter, 1997, pp. 19-23, which is incorporated by reference herein in its entirety.

Expected covariances of security returns, which are the matrix elements of Q, are difficult to estimate accurately. For N assets, there are N (N+1)/2 separate variances and covariances to be estimated. The number of securities that may be part of a portfolio, N, is often over a 1000, which implies that over 500,000 values must be estimated. Risk models typically cover all the assets in the asset universe, not just the assets with holdings in the portfolio, so N can be considerably larger than the number of assets in a managed or benchmark portfolio.

To obtain reliable variance or covariance estimates based on historical return data, the number of historical time periods used for estimation should be of the same order of magnitude as the number of assets, N. Often, there may be insufficient historical time periods. For example, new companies and bankrupt companies have abbreviated historical price data and companies that undergo mergers or acquisitions have non-unique historical price data. As a result, the covariances estimated from historical data can lead to matrices that are numerically ill-conditioned. Such covariance estimates can be poor and are of limited value for risk estimation, portfolio construction, and portfolio attribution.

Factor risk models were developed, in part, to overcome these short comings. See for example, R. C. Grinold, and R. N. Kahn, Active Portfolio Management: A Quantitative Approach for Providing Superior Returns and Controlling Risk, Second Edition, McGraw-Hill, New York, 2000, which is incorporated by reference herein in its entirety, and R. Litterman, Modern Investment Management: An Equilibrium Approach, John Wiley and Sons, Inc., Hoboken, N. J., 2003 which is incorporated by reference herein in its entirety. These two references give overviews of how factor risk models have been constructed and evolved over the last three decades as well as detailing various uses of factor risk models for constructing portfolios, predicting risk, and meaningfully attributing portfolio performance.

Factor risk models represent the expected variances and covariances of security returns using a set of M factors, where M<<N, that are derived using statistical, fundamental, or macro-economic information or a combination of any of such types of information. Given exposures of the securities to the factors and the covariances of factor returns, the covariances of security returns can be expressed as a function of the factor exposures, the covariances of factor returns, and a “remainder”, called the specific risk or specific variance of each security. Factor risk models typically have between 20 and 200 factors. With 200 factors and 1,000 securities, the total number of values that must be estimated is just over 21,000, as opposed to over 500,000.

A substantial advantage of factor risk models is that since, by construction, M<<N, factor risk models do not need as many historical time periods to reliably estimate the covariances of factor returns and thus are less susceptible to the ill-conditioning problems that arise when estimating the elements of Q individually.

A factor-risk model representation of Q is given by the matrix equation

Q=BΩB^{T}+Δ (3)

where

Q is an N by N covariance matrix

B is an N by M matrix of factor exposures (also called factor loadings)

Ω is an M by M matrix of factor covariances

Δ is an N by N matrix of security specific covariances; often, Δ is taken to be a diagonal matrix of security specific variances. In other words, the off-diagonal elements of Δ are often neglected (e.g., assumed to be vanishingly small and therefore not explicitly computed or used).

The covariance and variance estimates in the matrix of factor-factor covariances, Ω, and the (possibly) diagonal matrix of security specific covariances, Δ, are estimated using a set of historical estimates of factor returns and asset specific returns.

The historical factor return for the i-th factor and the p-th historical time period is denoted as f₍ᵢ₎^{(p)}. Then, the covariance of the i-th and j-th factors is

Ωᵢⱼ=Covₚ(f₍ᵢ₎^{(p)},f₍ⱼ₎^{(p)}) (4)

where the notation Covₚ( ) indicates computing an estimate of the covariance over the time history of the variables. The historical specific return for the i-th asset and the p-th historical time period is denoted as ε₍ⱼ₎^{(p)}. For the case of a diagonal specific covariance matrix, the specific variance of the i-th asset is

Δᵢᵢ=Varₚ(ε₍ᵢ₎^{(p)}) (5)

where the notation Varₚ( ) indicates computing an estimate of the variance over the time history of the variable.

Both the covariance and variance computations may utilize techniques to improve the estimates. For example, it is common to use exponential weighting when computing the covariance and variance. This approach is described in Litterman and in Grinold and Kahn. US Patent Application Publication No. U.S. 2004/0078319 by Madhavan et al. also describes aspects of factor risk model estimation and is incorporated by reference herein in its entirety.

The covariance and variance estimates may also incorporate corrections to account for autocorrelation of the time series of asset and factor returns. This correction is described in W. K. Newey and K. D. West, “A Simple, Positive Semi-Definite, Heteroskedasticity and Autocorrelation Consistent Covariance Matrix,” Econometrica, 55(3): 703-708, 1987, which is incorporated by reference herein in its entirety

The covariance and variance estimates may also incorporate corrections to account for the different times at which assets are traded across the globe. For example, U.S. Pat. No. 8,533,107 describes a returns-timing correction for factor and specific returns and is incorporated by reference herein in its entirety.

The covariance and variance estimates may also incorporate corrections to make the estimates more responsive and accurate. For example, U.S. Pat. No. 8,700,516 describes a dynamic volatility correction for computing covariances and variances, and is incorporated by reference herein in its entirety.

A factor risk model may be corrected for missing factor risk by adding a new factor to a previously calibrated factor risk model. By making this new factor orthogonal to all the factors in the original risk model as well as overlapping as much as possible with the vector of portfolio holdings, the risk estimate including the new factor may make a factor risk model substantially more accurate. U.S. Pat. Nos. 7,698,202 and 8,315,936 describe such an approach to modifying factor risk models and are incorporated by reference herein in their entirety.

U.S. Patent Application No. 2013/0304671 which is incorporated by reference herein in its entirety describes an improved factor risk model with two or more estimates of specific risk.

U.S. Pat. No. 7,024,388 (Stefek et al.) and P. Chen, F. Hemmati, N. G. Tone, “An Integrative Approach to Modeling the World Equity Market”, Citeseer online database, June 2000 (Chen et al.), which are incorporated by reference herein in their entirety, describe an approach for modelling the factor-factor covariance matrix using global factors, as well as, methodologies for aggregating different factor risk models into one large factor risk model.

A different two-pass approach is described by R. Staub, “Multilayer Modeling of a Market Covariance Matrix,” The Journal of Portfolio Management, pp. 33-44, Spring 2006, which is incorporated by reference herein in its entirety. In this approach, a first pass estimate produces a covariance matrix between global factors or markets, and then a second pass is used to produce a more granular factor-factor covariance matrix.

An approach to integrating more than one factor risk model into an aggregate factor risk model is described by P. G. Sheppard, “Integrating Multi-Market Risk Models,” Journal of Risk, 10(2), 25-45, Winter 2007/2008, which is incorporated by reference herein in its entirety. Like U.S. Pat. No. 7,024,388 and Chen et al., supra, this work considers the problem of producing a consistent, aggregated risk model from a set of distinct factor models based on limited time series data.

Chen et al., Stefek et al., Shepard, and Staub all use a “factor-of-factors” approach in which research is done to discover previously unknown global factors that may possibly prove useful for modelling the correlation between the factors of the original factor risk models. In aggregated risk models, such as described by Stefek et al., Chen et al., and Sheppard, the number of factors can be quite large, say on the order of thousands. As Stefek et al., puts it, “Computing a 2000 times 2000 sample covariance matrix from limited times series data leads to degenerate results.” (Stefek, col. 9, line 66).

U.S. Pat. No. 7,324,978, which is incorporated by reference herein in its entirety, describes a numerical optimization approach for advantageously rotating a factor-factor covariance matrix to achieve consistency. This patent describes a variation of the well-known solution to the Orthogonal Procrustes Problem, which was solved in its entirety in 1964 by P. H. Schonemann, “A Generalized Solution of the Orthogonal Procrustes Problem,” Psychometrika, 31(1), 1-10, March, 1966, and is incorporated by reference herein in its entirety.

In G. Miller, “Needles, Haystacks, and Hidden Factors,” Journal of Portfolio Management, vol. 32(2), pp. 25-32, 2006, which is incorporated by reference herein in its entirety, a two pass approach is described for estimating a factor risk model. In the first pass, fundamental factor exposures are calculated based on historical data, and then the factor returns to these fundamental factors are estimated using cross-sectional regression. Then, rather than taking the residual returns of this process and using them to compute the specific variances, a set of statistical factor exposures are computed to describe these residual returns. Then, the residuals of this second pass are used to compute the specific variances. The idea is that the second statistical pass can find important factors for describing the asset returns that may have been over-looked by the set of fundamental factors. The two passes result in a “hybrid” factor risk model in that it includes both fundamental and statistical risk factors.

One of the practical questions in factor risk modelling is determining the number of factors, M, to use in a factor risk model. J. Bai and S. Ng, “Determining the Number of Factors in Approximate Factor Models,” Econometrica, vol. 70(1), pp. 191-221, January 2002, which is incorporated by reference herein in its entirety, describe a study in which statistical factor models were computed with different numbers of factors. They propose a number of criteria to judge the accuracy of the factor risk model as a function of the number of factors.

### SUMMARY OF THE INVENTION

In the present invention, improved methods for estimating asset-asset covariance matrices for different universes of potential investments are addressed. Such improvements can be used to predict risk, construct portfolios, and document historical performance of portfolios using methods such as performance attribution.

Notwithstanding the prior art, the present invention recognizes the issue of determining not just the number of factors but also correctly estimating the best factor-factor covariances in a factor risk model remains a challenge. First, the data issue remains. There is a need to better estimate the factor-factor covariance matrix with limited historical data, especially for large numbers of factors. Without accurate estimation techniques, the factor-factor covariance matrix may include spurious correlations and even vanishing eigenvalues. Aspects of the present invention address such needs.

Second, even if a large factor-factor covariance matrix is well estimated, attribution of the performance of a portfolio from such a risk model may be difficult because, with so many possible sources of correlated returns, it may be difficult to identify dominant sources of return. Hence, there is a need to effectively identify the dominant factors in a factor-factor covariance matrix that best describe the sources of return and risk. Again, aspects of the present invention address such needs.

The present invention proposes an improved method, computer based system, and software for estimating the factor-factor covariance estimates of a given factor risk model. The invention is expected to be particularly effective for factor risk models with large number of factors. However, unlike previous proposals, the present invention is equally applicable to single distinct risk models that may not have a large number of factors.

The present invention recognizes that existing computer based systems, methods and software for estimating factor risk models can lead to factor-factor covariance matrices with spurious correlations and possibly vanishing eigenvalues.

One goal of the present invention, then, is to describe a methodology, computer-based system, and software that improves the factor-factor covariance estimate of a single, previously calibrated factor risk model. The proposed improvements will substantially reduce the likelihood of spurious correlations and vanishing eigenvalues.

Another goal of the present invention is to enable users of the factor risk model to more easily identify dominant factors that explain the return and risk of a portfolio. Such performance attribution is a key part of modern investing, and improvements such as those described here are extremely useful and important to such ends.

Significantly, the present invention requires only one factor risk model. In the prior art, the problem considered always involves two or more factor risk models. Second, in the present invention, no new factors need to be determined, researched or discovered. All the factors to be used are factors in the original factor risk model. No research or effort need be done to determine new factors. The approach of the present invention is a substantial improvement over and different than the prior art.

It is true that in one aspect of the present invention, the user must determine the factor groups, and that choice may require research and effort. However, this is substantially less effort than discovering previously unknown factors and then researching their usefulness.

Another important improvement of the present approach is that, once the original factor risk model is given, no additional data is required to implement the method, apart from specifying the factor groups. In particular, in one embodiment of the present invention, a time series of factor returns is not needed, since the original factor risk model already provides high quality estimates of the covariance of all the factors. Thus, it is relatively easy to experiment and try different factor groups to see which are most advantageous during a particular time or under particular market conditions. The prior art does not lend itself easily to such experimentation. In a second embodiment of the present invention, a time series of factor returns is used to quantitatively assess the accuracy of the original and the modified factor-factor covariance matrix.

To be sure, if one wanted to compute different covariance estimates for the factors using different half-lives or time windows, the present method could easily accommodate those estimates. In that case, the user could decide if any form of consistency of the original and modified factor-factor covariance matrix was desired, and linear transformations could be applied to the modified factor-factor covariance matrix to achieve that.

However, one of the advantages of the present invention is that there is no need to do additional transformations to achieve consistency. In part, this is because there is only one factor risk model, so consistency is not an issue. In the present invention, the original block diagonals of the factor-factor covariance are unchanged. Only the off-diagonal blocks relating the subordinate second and third groups of factors are modified. Thus, this approach has an internal consistency, which is advantageous.

Another important advantage of the present invention stems from the factor that utilizes only one, original, well estimated factor risk model. In the prior art, which aggregates two or more factor risk models, the time frame and data history used to construct each risk model may vary widely. A short-horizon factor risk model may use high frequency data with a history of days or weeks, while a longer-horizon factor risk model may use daily or monthly or even quarterly data, such as announced earnings, as well as, data ranging over several years. Merging these disparate risk estimates into one factor risk model can be an onerous and difficult challenge. However, since the present invention starts with a single, well-estimated factor risk model, it avoids these difficult issues.

A more complete understanding of the present invention, as well as further features and advantages of the invention, will be apparent from the following Detailed Description and the accompanying drawings.

### BRIEF DESCRIPTION OF THE DRAWINGS

FIG. 1 shows a computer based system which may be suitably utilized to implement the present invention;

FIG. 2 illustrates a distribution of realized correlations between the industry and country factors;

FIG. 3 illustrates a distribution of predicted country versus industry correlations for an unmodified factor risk model;

FIG. 4 illustrates a distribution of predicted country versus industry correlations for a modified factor risk model;

FIG. 5 illustrates a graph of cumulative returns for a set of backtests testing the modified factor risk model;

FIG. 6 illustrates a table of performance statistics for a set of backtests comparing the present invention with the prior art;

FIG. 7 illustrates an original, unadjusted factor-factor covariance matrix for a factor risk model with seven factors;

FIG. 8 illustrates an adjusted factor-factor covariance matrix for a factor risk model with seven factors; and

FIG. 9 illustrates a flow chart of the steps of an embodiment of the present invention.

### DETAILED DESCRIPTION

The present invention may be suitably implemented as a computer based system, in computer software which is stored in a non-transitory manner and which may suitably reside on computer readable media, such as solid state storage devices, such as RAM, ROM, or the like, magnetic storage devices such as a hard disk or solid state drive, optical storage devices, such as CD-ROM, CD-RW, DVD, Blue Ray Disc or the like, or as methods implemented by such systems and software. The present invention may be implemented on personal computers, workstations, computer servers or mobile devices such as cell phones, tablets, IPads™, IPods™ and the like.

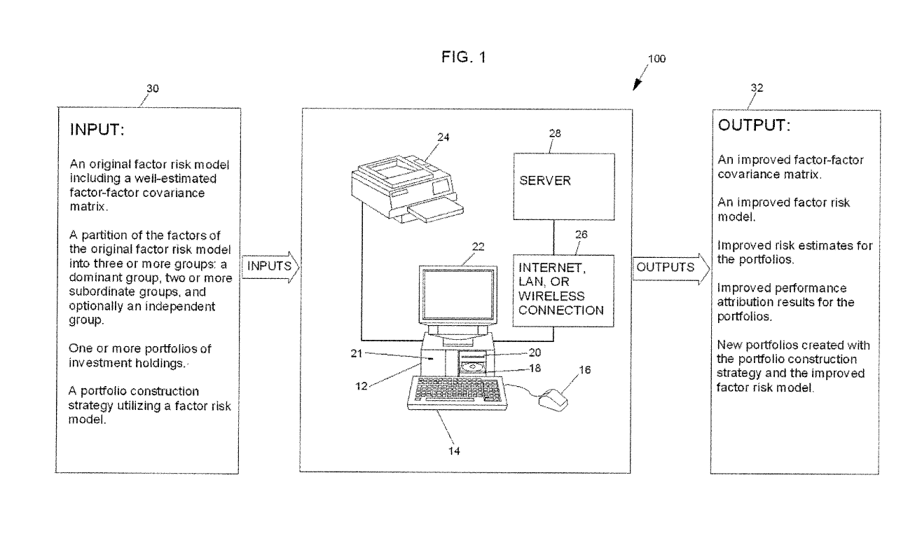

FIG. 1 shows a block diagram of a computer system 100 which may be suitably used to implement the present invention. System 100 is implemented as a computer or mobile device 12 including one or more programmed processors, such as a personal computer, workstation, or server. One likely scenario is that the system of the invention will be implemented as a personal computer or workstation which connects to a server 28 or other computer through an Internet, local area network (LAN) or wireless connection 26. In this embodiment, both the computer or mobile device 12 and server 28 run software that when executed enables the user to input instructions and calculations on the computer or mobile device 12, send the input for conversion to output at the server 28, and then display the output on a display, such as display 22, or print the output, using a printer, such as printer 24, connected to the computer or mobile device 12. The output could also be sent electronically through the Internet, LAN, or wireless connection 26. In another embodiment of the invention, the entire software is installed and runs on the computer or mobile device 12, and the Internet connection 26 and server 28 are not needed.

As shown in FIG. 1 and described in further detail below, the system 100 includes software that is run by the central processing unit of the computer or mobile device 12. The computer or mobile device 12 may suitably include a number of standard input and output devices, including a keyboard 14, a mouse 16, CD-ROM/CD-RW/DVD drive 18, disk drive or solid state drive 20, monitor 22, and printer 24. The computer or mobile device 12 may also have a USB connection 21 which allows external hard drives, flash drives and other devices to be connected to the computer or mobile device 12 and used when utilizing the invention. It will be appreciated, in light of the present description of the invention, that the present invention may be practiced in any of a number of different computing environments without departing from the spirit of the invention. For example, the system 100 may be implemented in a network configuration with individual workstations connected to a server. Also, other input and output devices may be used, as desired. For example, a remote user could access the server with a desktop computer, a laptop utilizing the Internet or with a wireless handheld device such as cell phones, tablets and e-readers such as an IPad™, IPhone™, IPod™, Blackberry™, Treo™, or the like.

One embodiment of the invention has been designed for use on a stand-alone personal computer running in Windows 7. Another embodiment of the invention has been designed to run on a Linux-based server system.

According to one aspect of the invention, it is contemplated that the computer or mobile device 12 will be operated by a user in an office, business, trading floor, classroom, or home setting.

As illustrated in FIG. 1, and as described in greater detail below, the inputs 30 may suitably include an original factor risk model including a well-estimated factor-factor covariance matrix; a partition of the factors of the original factor risk model into three or more groups: a dominant group, two or more subordinate groups, and optionally an independent group; one or more portfolios of investment holdings; and a portfolio construction strategy utilizing a factor risk model. As further illustrated in FIG. 1, and as described in greater detail below, the system outputs 32 may suitably include an improved factor-factor covariance matrix; an improved factor risk model; improved risk estimates for the portfolios, if any; improved performance attribution results for the portfolios, if any; and new portfolios created with the portfolio construction strategy, if any.

The output information may appear on a display screen of the monitor 22 or may also be printed out at the printer 24. The output information may also be electronically sent to an intermediary for interpretation. For example, the performance attribution results for many portfolios can be aggregated for multiple portfolio report. Other devices and techniques may be used to provide outputs, as desired.

With this background in mind, we turn to a detailed discussion of the invention and its context.

Consider a single, original, existing, well-estimated factor risk model. The exposure, factor-factor covariance, specific risk, and factor returns are denoted by B, Ω, Δ, and f.

The factors of this risk model have been partitioned into distinct groups of factors. That is, all the factors in the factor risk model are assigned to one and only one factor group. Such a factor partitioning may be described as non-intersecting groups of factors or non-overlapping groups of factors. Every factor is assigned to a factor group, but no factor is assigned to more than one factor group. This is the definition of the word partitioning. In the case of three groups of factors, the existing factor risk model is written as

$$B = [ \begin{matrix}{B}_{1} & {B}_{2} & {B}_{3}\end{matrix} ] \\ Δ = [ Δ ] \\ f = [ \begin{matrix}{f}_{1} \\ {f}_{2} \\ {f}_{3}\end{matrix} ] \\ Ω = [ \begin{matrix}{Ω}_{11} & {Ω}_{12} & {Ω}_{13} \\ {Ω}_{12}^{T} & {Ω}_{22} & {Ω}_{23} \\ {Ω}_{13}^{T} & {Ω}_{23}^{T} & {Ω}_{33}\end{matrix} ] \qquad ( 6 )$$

A similar decomposition is formed for four or more groups.

As a specific example, consider a global equity risk model that has four groups of factors: a market factor, a set of country factors, a set of industry factors, and a set of all other factors (e.g., style factors, currencies, local factors). With the present invention, improved estimates of the covariance or correlation between these groups may be readily sought.

Past research has considered how best to model industry and country factors in factor risk models because these factors are linearly dependent: the sum of all the industry factors is a vector of ones, as is the sum of all the country factors. See, for example, S. L. Heston and K. G. Rouwenhorst, “Does Industrial Structure Explain the Benefits of International Diversification?” Journal of Financial Economics, 36 (1994), 3-27; S. L. Heston and K. G. Rouwenhorst, “Industry and Country Effects in International Stock Returns,” The Journal of Portfolio Management, vol. 21(3), pp. 53-58, Spring 1996; J. M. Griffin and G. A. Karolyi, “Another Look at the Role of the Industrial Structure of Markets for International Diversification Strategies,” Journal of Financial Economics, vol. 50(3), pp. 351-373, 1998; and S. Cavaglia, C. Brightman, M. Aked, “On the Increasing Importance of Industry Factors: Implications for Global Portfolio Management,” March 2000, available at https://faculty.fuqua.duke.edu/˜charvey/Teaching/IntesaBci_{—}2001/cavaglia.pdf, each of which is incorporated by reference herein in its entirety.

Numerous algorithmic techniques have been proposed to best compute industry and country factor returns given that they are linearly dependent. For example, in Chen et al., it is proposed to include a “global equity return factor” to capture the market return and then constrain the sum of the industry factor returns to be zero as well as the sum of the country factor returns to be zero. Other approaches include two pass estimation procedures in which one set of returns (say countries) is estimated on the first pass, and the other set of returns (industries) is estimated on the second pass.

The present invention recognizes that it proves helpful to model the factor returns of the subordinate second and third factor groups as functions of the dominant first factor group. In the notation below, a subscript one will indicate the dominant first factor group, while a subscript two or three will indicate either the subordinate second or third group, respectively. The models are then estimated:

f₂=β₂₁f₁+ε₂₁ (7)

f₃=β₃₁f₁+ε₃₁ (8)

These models imply that the factors in the dominant first group are coarser than those of the subordinate second and third groups, and, conversely, those of the subordinate second and third groups are more granular than those of the dominant first group. It is further assumed

Cov(ε₂₁,f₁)=0 (9)

Cov(ε₃₁,f₁)=0 (10)

Cov(ε₂₁,ε₃₁)=0 (11)

Then, by direct computation, the covariance estimates are

Cov(f₂,f₁)=β₂₁Ω₁₁ (12)

Cov(f₃,f₁)=β₃₁Ω₁₁ (13)

Cov(f₂,f₃)=β₂₁Ω₁₁β₃₁^{T} (14)

For more complex partitionings, the formula (14) can be applied recursively. Suppose, for example, that we have a partitioning structure such that, for the j-th factor group, we have:

f₆⊂f₃⊂f₁ and f₄⊂f₂⊂f₁ (15)

then, the modelling assumptions above implies

Cov(f₄,f₆)=β₆₃β₃₁Ω₁₁β₂₁^{T}β₄₂^{T} (16)

The above modelling can be recast in an alternative but equivalent notation in terms of conditional expectation and variance. Equations (7) to (10) are equivalent to

E(f₂|f₁)=β₂₁f₁ (17)

and

E(f₃|f₁)=β₃₁f₁ (18)

Expression (11) can be recast as

Cov(f₂,f₃|f₁)=0 (19)

The law of total covariance states that

Cov(f₂,f₃)=E(Cov(f₂,f₃|f₁))+Cov(E(f₂|f₁),E(f₃|f₁)) (20)

Substituting in the modeling assumptions (17), (18), and (19), we obtain

Cov(f₂,f₃)=0+Cov(β₂₁f₁,β₃₁f₁)=β₂₁Ω₁₁β₃₁^{T} (21)

which, of course, is identical to (14).

Using the ordinary least squares method to model the factors of the subordinate second and third groups as functions of the factors of the dominant first group, the least-squares estimate or model is given by

β₂₁=Ω₂₁Ω₁₁⁻¹ (22)

In other words, the scaling matrix, β₂₁, relating the factors of the second, subordinate group of factors is the product of the covariance of the second subordinate group and first dominant group of factors (Ω₂₁) multiplied by the inverse of the variance of the first dominant factor group (Ω₁₁). Ordinary least squares automatically gives the conditions (9) and (10); or alternatively conditions (17) and (18). Ordinary least squares do not ensure satisfaction of conditions (11) or (19). The conditions described in equations (11) and (19), indicating that covariance of the residuals of both models is small, is a measure of the goodness of fit or quality of the modelling. If the dominant first group of factors and subordinate second and third groups of factors are well chosen, then these conditions will be true and the model will represent the underlying data well.

We now return to the factor-factor covariance matrices, and consider the substitution

\tilde{Ω}₂₃=β₂₁Ω₁₁β₃₁^{T}=Ω₂₁Ω₁₁⁻¹Ω₁₃ (23)

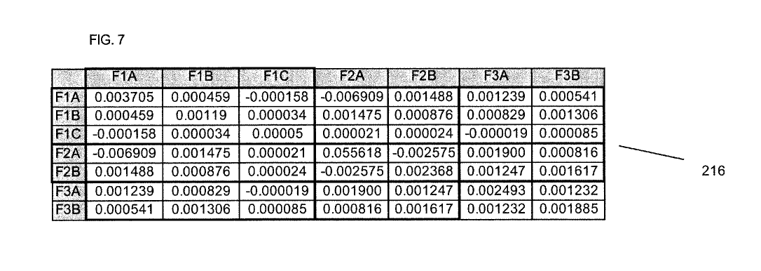

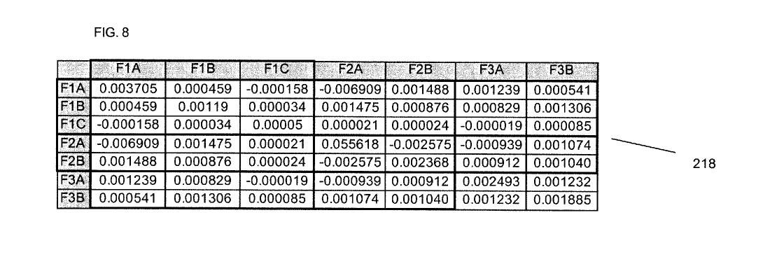

In other words, as detailed in (6), we have a modified factor-factor covariance matrix

$$\tilde{Ω} = [ \begin{matrix}{Ω}_{11} & {Ω}_{12} & {Ω}_{13} \\ {Ω}_{12}^{T} & {Ω}_{22} & ( {Ω}_{21} {Ω}_{11}^{- 1} {Ω}_{13} ) \\ {Ω}_{13}^{T} & ( {Ω}_{31} {Ω}_{11}^{- 1} {Ω}_{12} ) & {Ω}_{33}\end{matrix} ] \qquad ( 24 )$$

in which the factor covariance between the subordinate second and third groups of factors is replaced by a new estimate that depends only on the original covariances of the dominant first of factors, and the original covariances of the subordinate second and third groups of factors. Note that the block diagonals of the modified factor-factor covariance matrix are not changed in the modified matrix (24). The only changes in the modified factor-factor covariance matrix are the correlations or off-diagonal blocks relating the two subordinate groups of factors. Further illustration of the calculations involved are shown below in connection with the example of FIGS. 7 and 8.

As discussed further below, the approximation (24) has advantages over (6). The advantages of (24) are illustrated through a series of real world examples. As an initial, complete, fully calibrated factor risk model Axioma's World-Wide, Fundamental Factor, Medium Horizon, Equity Risk Model is selected. This model is a factor risk model covering all traded equities in the world that is updated daily and has a history going back to January 1997. The factors in this risk model include a market factor, industry factors, country factors, currency factors, local factors, and style factors. When this model is constructed, the sum of the industry factor returns and the sum of the country factor returns are constrained to be zero, so that the market factor unambiguously measures a general market return.

Historically, researchers have been focused on the performance of the industry and country factors. Here, these two groups are taken as the subordinate second and third groups in our modelling, e.g., the more granular groups. Then, for the dominant first group, the coarse group, we take all the other factors in the risk model. That is, the dominant first group comprises the market, style, local, and currency factors.

As a first experiment, the factor-factor correlations for the original factor risk model and the modified factor-factor covariance matrix are computed. This computation is performed monthly from Jun. 30, 2000 to Feb. 28, 2014. Then, the statistics for the correlations of the industry factors to the country factors for both models are examined.

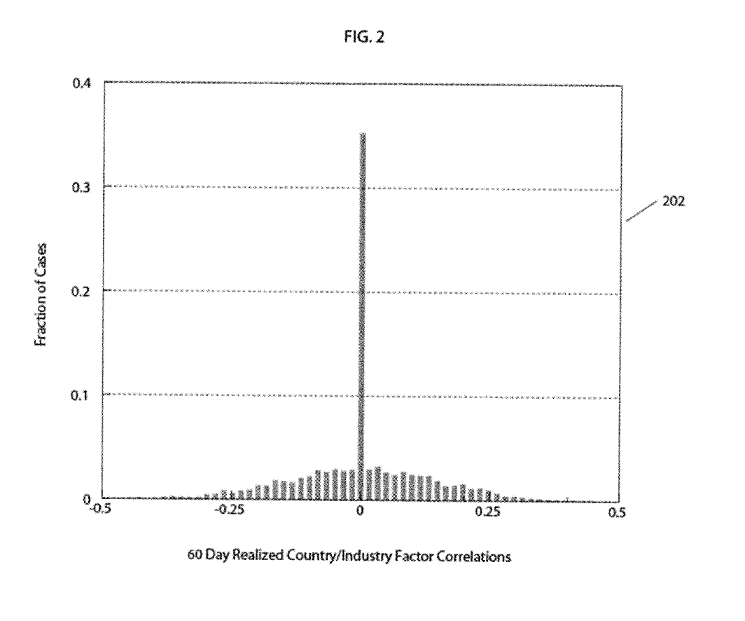

FIG. 2 shows a distribution 202 of 60-day, realized country versus industry correlations over this time period. These are the realized correlations of factor returns observed going forward in Axioma's factor risk model for each of the 60 trading days after a particular risk model was calibrated. In other words, these results are the “true” correlations the factor risk model attempts to predict. As can be seen, the realized correlations have a large number of extremely small realized correlations. In fact, almost a third of the realized correlations are essentially vanishing. The remaining two thirds of the correlations are spread out symmetrically between values of −0.3 and +0.3.

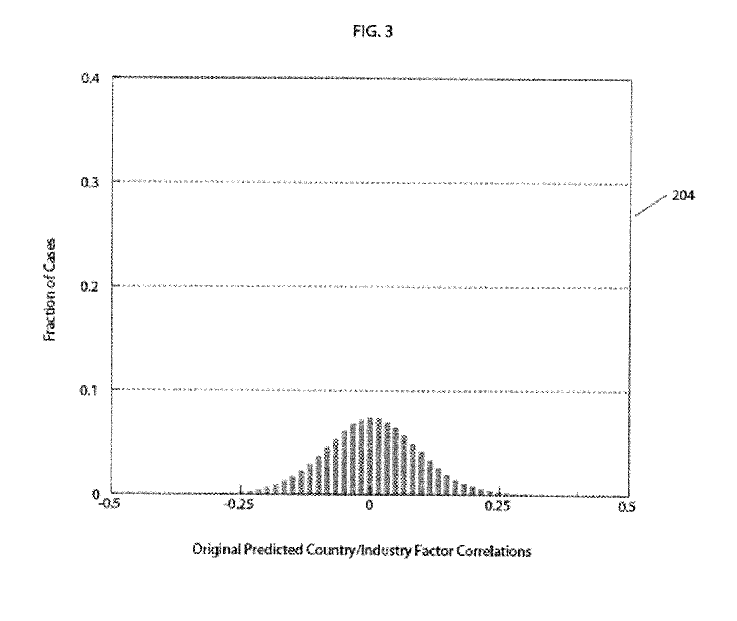

FIG. 3 shows the distribution 204 of the predicted country versus industry correlations over this time period using the initial, unmodified factor risk model. The distribution is bell-shaped and smooth. Although the most common correlation observed is zero, the number of very small correlations is less than 8% rather than the large value of almost a third observed in the realized correlations of FIG. 2. This difference indicates somewhat inaccurate predicted correlations in the original factor risk model.

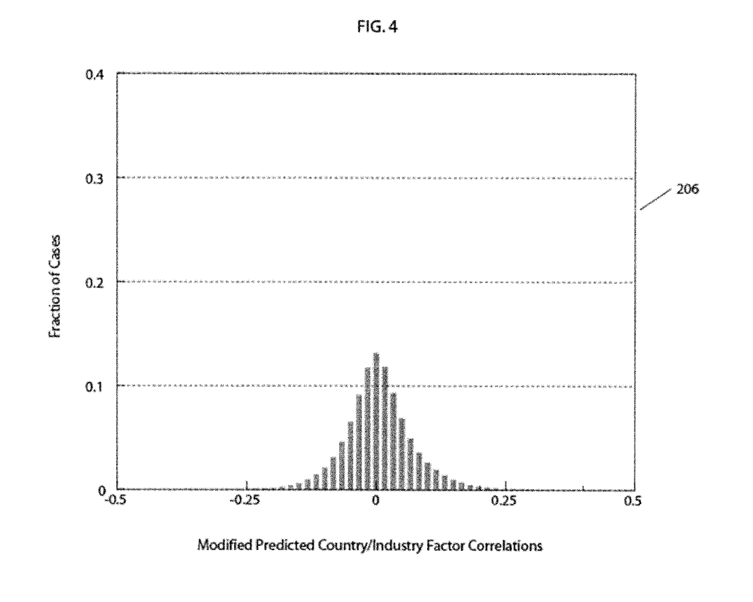

FIG. 4 shows the distribution 206 of the predicted country versus industry correlations over this time period using the modified factor risk model. The distribution has a very different shape than the distribution 204 shown in FIG. 3. Distribution 206 has a much higher concentration of small correlations, with at least 12% vanishing. In other words, this distribution 206 is more similar to the realized distribution 202 than the original distribution 204. This initial test indicates that the proposed modification to the factor-factor covariance can substantially improve the predicted correlations of a factor risk model.

A second experiment was performed using four factor groups. The industry and country factors were still the subordinate second and third groups of factors. However, the currency factors were taken out as a fourth independent group that was unmodified. That leaves the style, local, and market factors in the first dominant group. The results of this test were indistinguishable from those of the first experiment.

A third experiment was performed by backtesting using the modified factor risk model and comparing its performance to that of the original model. In this backtest, we attempted to track the FTSE Developed benchmark index using monthly rebalancings from July 2000 to February 2014 (165 monthly rebalances). At each monthly rebalance, a long only portfolio was constructed with at most 100 holdings that minimized the predicted tracking error to the benchmark, which held on average 1950 different holdings. In addition to restricting the optimized portfolios to at most 100 names, the portfolios were long only and any individual name could only hold at most 5% of the total portfolio value. Two optimized portfolios were constructed. In the first case, the factor risk model used was Axioma's Fundamental Factor, Medium Horizon, World-Wide Equity Risk Model. In the second case, the factor-factor covariance matrix of Axioma's factor risk model was modified by grouping the factors into industries (the second subordinate group), countries (the third subordinate group), and all other factors (the first dominant group).

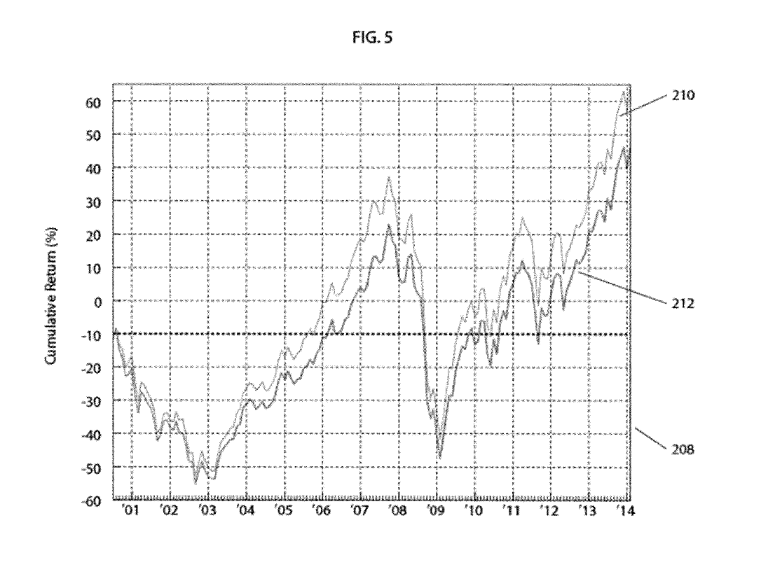

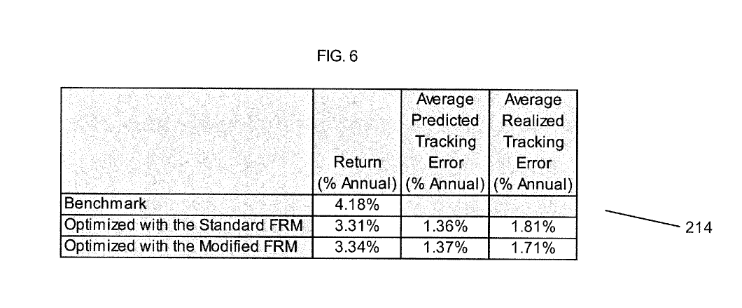

In FIG. 5, the chart 208 shows the cumulative returns of the benchmark 210 as well as the cumulative returns of both optimized portfolios 212. Although there are two optimized portfolios, their cumulative returns are indistinguishable on the chart, and both are represented by the thick line 212. The annualized return of the benchmark over this time period was 4.18%. The annualized return of the portfolio of 100 names optimized using the standard Axioma factor risk model was 3.31%. The annualized return of the portfolio of 100 names using the modified factor risk model was 3.34%. These numbers are shown in the Table 214 in FIG. 6 In other words, the backtest using the modified factor risk model had a three basis point advantage over the standard model. Although this is a small advantage, it does indicate that the modified factor risk model may give improved performance when constructing and backtesting portfolios.

A more important statistic for this particular backtest is a comparison of tracking error of the two optimized portfolios which are also provided in table 214 of FIG. 6. In terms of predicted tracking error, the portfolio optimized with the standard factor risk model had, on average, a predicted tracking error of 1.36% annual volatility, while the portfolio optimized with the modified factor risk model had, on average, a predicted tracking error of 1.37%. These predicted tracking errors are virtually indistinguishable, although the standard model produces slightly smaller predicted tracking errors. However, in terms of realized tracking error, the modified factor risk model out-performed the standard factor risk model substantially. The portfolio optimized with modified factor risk model had realized tracking error of 1.71% annual volatility, while the portfolio optimized with standard factor risk model had realized tracking error of 1.81% annual volatility, a full 10 basis points higher. The results indicate that the modified factor risk model has performance advantages over the standard risk model.

Next, aspects of the present invention are illustrated with a simple example.

Consider a factor risk model with seven factors. In the first dominant group of factors, the three factors are named F1A, F1B, and F1C. In the second subordinate group of factors, the two factors are named F2A and F2B. In the third subordinate group of factors, the two factors are named F3A and F3B.

In FIG. 7, table 216 shows a factor-factor covariance matrix for these seven factors. The entries are covariance numbers in units of annual covariance.

In FIG. 8, table 218 shows a modified factor-factor covariance matrix derived from table 216 in which the covariances between factors in subordinate groups two and three have been modified. Whereas in the original factor-factor covariance matrix, the four covariances had values of 0.001900, 0.000816, 0.001247, and 0.001617, in the modified covariance matrix these values are replaced by −0.000939, 0.001074, 0.000912, and 0.001040. These numbers are derived using the formula in equations (23) and (24), which involve simple matrix computations involving the original covariances of factors in groups one (the dominant first group), two and three (the two subordinate groups of factors); that is, covariances present in the original factor-factor covariance matrix of table 216. Note that only these four numbers are changed. Since the matrix is symmetric, that means that eight of the 49 numbers in table 218 are changed. The other 41 numbers are not modified.

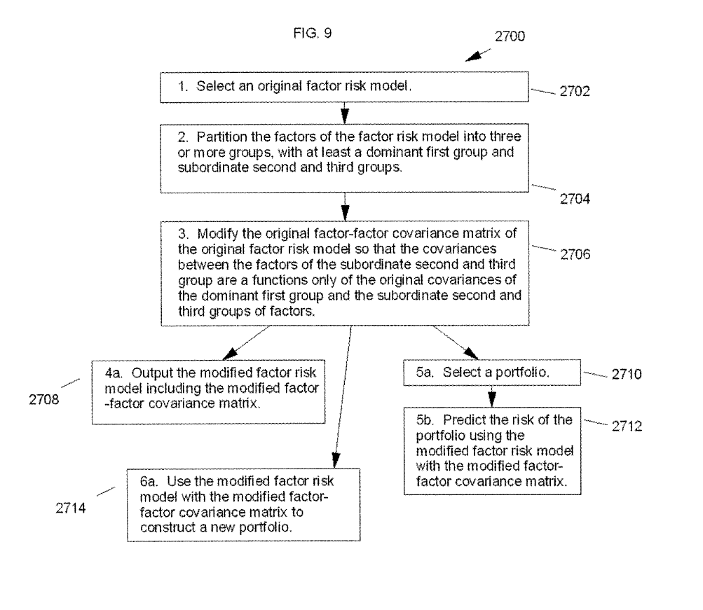

FIG. 9 shows a flow diagram illustrating the steps of a process 2700 embodying the present invention. In step 2702, an original factor risk model is selected. In step 2704, a partition of the factors of the factor risk model is determined grouping the factors of the factor risk model into three or more groups, with at least a dominant first group and subordinate second and third groups. In one presently preferred embodiment the dominant first group includes at least a market factor that captures the broad market return and the subordinate second and third group are industry factors and country factors. In step 2706, the original factor-factor covariance matrix of the original factor risk model is modified so that the covariances between the factors of the subordinate second and third groups are functions only of the original covariances of the dominant first group, and the subordinate second and third groups. At this point in the process, three different steps may be taken, as indicated by the flow diagram. In step 2708, the modified factor risk model including the modified factor-factor covariance matrix is output. This output may then be distributed and sold. Alternatively, in step 2710, a portfolio is selected. Then, in step 2712, the risk of the portfolio is predicted using the modified factor risk model with the modified factor-factor covariance matrix. A third alternative is shown in step 2714 where the modified factor risk model with the modified factor-factor covariance matrix is used to construct a new portfolio of investment holdings. The objectives and constraints for constructing this new portfolio can be selected from a wide variety of options. For example, Axioma's portfolio construction tool, Axioma Portfolio™, possesses a large toolbox of common and specialized objectives and constraints that can be utilized together with a modified factor risk model to construct a new portfolio.

In the present invention, the observed factors returns of the subordinate second and third groups of factors are modelled as functions of the observed factor returns in the first dominant group. In particular, in this modelling, if it is assumed that the correlations of the residuals of the second and third group models are uncorrelated, as expressed in equations (11) and (19). If f₁, the dominant factor return, captures all meaningful correlation between f₂ and f₃, the two subordinate factor returns, then the lack of correlation is likely to be true and the modelling assumptions will be good. However, if there exists a significant correlation between f₂ and f₃ that is not well represented by f₁, then the modelling assumptions may be less good. In this latter case, the modified factor-factor covariance matrix may not lead to an improved factor risk model.

Clearly, there are good choices for the factor groups and poor choices. In world-wide factor risk models, countries and industry factor groups are advantageous choices for the subordinate second and third groups of factors, as their impact and importance has been well studied and the mechanics of their modelling in terms of accounting for their linear dependence is usually somewhat ad hoc. In general, the present invention presents an advantageous tool for evaluating choices of factor groups.

Specifically, as illustrated in FIGS. 2, 3, and 4, it can be advantageous to compare the factor-factor covariance and correlation predictions of the original and different modified factor-factor covariance matrices to statistics computed using a time series history of factor returns. By comparing the realized performance results of the time series history of factor returns to the predictions of different, modified factor-factor covariance matrices, a preferred choice can be made. That is, different partitionings can be compared against each other for their fidelity to the realized factor returns. This comparison can help identify promising factor partitionings or groupings. Analysis of these promising factor partitionings will ensure that the final factor-factor covariance estimate minimizes the influence of noise in the input data used to construct the original factor risk model.

While the present invention has been disclosed in the context of various aspects of presently preferred embodiments, it will be recognized that the invention may be suitable applied to other environments consistent with the claims which follow.

I claim:

1. A non-transitory computer-readable medium having stored thereon computer-executable instructions which when executed by a programmed computer perform a method for modifying the factor-factor covariance matrix of a factor risk model, comprising:
electronically receiving by the programmed computer an original factor risk model, said original factor risk model comprising a set of factors, a matrix of factor exposures, a matrix of factor covariances, and a matrix of specific covariances;
partitioning by the programmed computer the factors of the original factor risk model into three or more groups of factors, the first three of which are a dominant first group, and a subordinate second group, and a subordinate third group;
determining a modified factor-factor covariance matrix in which the factor covariance between the second and third groups is replaced by a new estimate that depends only on the covariances of the first, second and third groups as defined by the original factor risk model;
determining a modified factor risk model that uses the matrix of factor exposures and matrix of specific covariances of the original factor risk model and the modified factor-factor covariance matrix; and
electronically outputting the modified factor risk model using an output device.

2. The non-transitory computer-readable medium of claim 1 where the method further determines an estimate of portfolio risk by:
determining a risk predicted by the modified factor risk model for a set of holdings in investment opportunities represented by the modified factor risk model which have been electronically input; and
electronically outputting the risk prediction using an output device.

3. The non-transitory computer-readable medium of claim 1 where the method further comprises determining a new portfolio of investments by:
evaluating an electronically input set of possible investment opportunities;
applying an electronically input maximum allowable predicted risk for the possible investment opportunities;
determining the investment holdings of the new portfolio selected from the set of possible investment opportunities such that the risk predicted by the modified factor risk model for the new portfolio is less than the maximum allowable predicted risk; and
electronically outputting the new portfolio holdings using an output device.

4. The non-transitory computer-readable medium of claim 1 where the method further determines a new portfolio of investments by:
determining investment holdings of the new portfolio from an electronically input set of possible investment opportunities such that a risk prediction for the new portfolio predicted by the modified factor risk model is minimized; and
electronically outputting the new portfolio using an output device.

5. A system for modifying the factor-factor covariance matrix of a factor risk model comprising:
a programmed processor; and
a memory having computer-executable instructions stored thereon, wherein the programmed processor executing the computer-executable instructions operates to:
recognize data electronically entered defining an original factor risk model, said original factor risk model comprising a set of factors, a matrix of factor exposures, a matrix of factor covariances, and a matrix of specific covariances;
partition the electronically entered data of the factors of the original factor risk model into three or more groups of factors, the first three of which are a first dominant group, a subordinate second group, and a subordinate third group;
determine a modified factor-factor covariance matrix in which the factor covariance between the second and third subordinate groups is replaced by a new estimate that depends only on the original covariances of the first, second, and third groups as defined by the original factor risk model;
determine a modified factor risk model that uses the matrix of factor exposures and matrix of specific covariances of the original factor risk model and the modified factor-factor covariance matrix; and
an output device to electronically display the modified factor risk model.

6. The system of claim 5 where an estimate of portfolio risk is determined by the programmed processor:
determining a risk prediction predicted by the modified factor risk model for a set of holdings in investment opportunities represented by the modified factor risk model; and
electronically outputting the risk prediction using an output device.

7. The system of claim 5 where the programmed processor determines a new portfolio by:
evaluating an electronically input set of possible investment opportunities applying an electronically input maximum allowable predicted risk for the set of possible investment opportunities; and
determining the investment holdings of the new portfolio selected from the set of possible investment opportunities such that the risk predicted by the modified factor risk model for the investment holdings is less than the maximum allowable predicted risk.

8. The system of claim 5 where the programmed processor determines a new portfolio of investments by:
determining investment holdings of the new portfolio from an electronically input set of possible investment opportunities such that the risk prediction predicted by the modified factor risk model for the new portfolio is minimized; and
electronically outputting the new portfolio using an output device.

9. A non-transitory computer-readable medium having stored thereon computer-executable instructions which when executed by a programmed computer perform a method for modifying the factor-factor covariance matrix of a factor risk model, comprising:
electronically receiving by the programmed computer an original factor risk model, said original factor risk model comprising a set of factors, a matrix of factor exposures, a matrix of factor covariances, and a matrix of specific covariances;
partitioning by the programmed computer the factors of the original factor risk model into three or more groups of factors, the first three of which are a dominant first group, a subordinate second group, and a subordinate third group;
determining a modified factor-factor covariance matrix in which the factor covariance between the second and third groups is replaced by a new estimate that depends only on the covariances of the first, second, and third groups as defined by the original factor risk model;
determining a modified factor risk model that uses the matrix of factor exposures and matrix of specific covariances of the original factor risk model and the modified factor-factor covariance matrix; and
electronically outputting the modified factor risk model using an output device.

10. The non-transitory computer-readable storage medium of claim 9 where an estimate of portfolio risk is determined by:
electronically inputting a set of holdings in investment opportunities represented by the modified factor risk model;
determining a risk prediction for the set of holding predicted by the modified factor risk model; and
electronically outputting the risk prediction using an output device.

11. The non-transitory computer-readable storage medium of claim 9 where a new portfolio of investments is determined by:
electronically inputting a set of possible investment opportunities;
electronically inputting a maximum allowable predicted risk for the new portfolio of investments; and
determining investment holdings of the new portfolio such that a risk predicted by the modified factor risk model for the investment holdings is less than the maximum allowable predicted risk.

12. The non-transitory computer-readable storage medium of claim 9 where a new portfolio of investments is determined by:
electronically inputting a set of possible investment opportunities;
determining investment holdings of the new portfolio such that a risk predicted by the modified factor risk model for the investment holdings is minimized; and
electronically outputting the new portfolio using an output device.

13. A non-transitory computer-readable medium having stored thereon computer-executable instructions which when executed by a programmed computer perform a method for modifying the factor-factor covariance matrix of a factor risk model comprising:
electronically receiving by the programmed computer an original factor risk model, said original factor risk model comprising a set of factors, a matrix of factor exposures, a matrix of factor covariances, and a matrix of specific covariances;
electronically receiving by the programmed computer a time series history of factor returns associated with the factors of the original factor risk model;
electronically receiving by the programmed computer two or more partitionings of the factors of the original factor risk model into three or more groups of factors, the first three of which are a dominant first group, a subordinate second group, and a subordinate third group;
for each partitioning, determining a modified factor-factor covariance matrix in which the factor covariance between the second and third groups is replaced by a new estimate that depends only on the covariances of the first, second, and third groups as defined by the original factor risk model;
comparing the modified factor-factor covariance predictions of each partitioning with a corresponding statistic produced by the time series history of factor returns;
determining a preferred partitioning based on the statistical comparison;
determining a modified factor risk model that uses the matrix of factor exposures and matrix of specific covariances of the original factor risk model and the modified factor-factor covariance matrix of the preferred partitioning; and
electronically outputting the preferred modified factor risk model using an output device.

14. The non-transitory computer readable medium of claim 13 where an estimate of portfolio risk is determined by
electronically inputting a set of holdings in investment opportunities represented by the preferred modified factor risk model;
determining a risk prediction for the set of holdings predicted by the preferred modified factor risk model; and
electronically outputting the risk prediction using an output device.

15. A system for modifying the factor-factor covariance matrix of a factor risk model, comprising:
a programmed processor; and
a non-transitory memory having computer-executable instructions stored therein, wherein the programmed processor executing computer-executable instructions operates to:
recognize data electronically entered defining an original factor risk model, said original factor risk model comprising a set of factors, a matrix of factor exposures, a matrix of factor covariances, and a matrix of specific covariances;
recognize electronically entered data comprising a time series history of factor returns associated with the factors of the original factor risk model;
recognize electronically entered data defining two or more partitionings of the factors of the original factor risk model into three or more groups of factors, the first three of which are referred to as a dominant first group, a subordinate second group, and a subordinate third group;
determine for each partitioning, a modified factor-factor covariance matrix in which the factor covariance between the second and third groups is replaced by a new estimate that depends only on the covariances of the first, second, and third groups as defined by the original factor risk model;
compare the modified factor-factor covariance predictions of each partitioning with a corresponding statistic produced by the time series history of factor returns;
determine a preferred partitioning based on the statistical comparison;
determine a preferred modified factor risk model that uses the matrix of factor exposures and matrix of specific covariances of the original factor risk model and the preferred modified factor-factor covariance matrix; and
an output device to electronically display the preferred modified factor risk model.

16. The system of claim 15 where an estimate of portfolio risk is determined by
electronically inputting a set of holdings in investment opportunities represented by the modified factor risk model;
determining a risk for the set of holdings predicted by the preferred modified factor risk model;
electronically outputting the risk prediction using an output device.

17. A non-transitory computer-readable medium having stored thereon computer-executable instructions which when executed by a programmed computer perform a method for modifying the factor-factor covariance matrix of a factor risk model, comprising:
electronically receiving by the programmed computer an original factor risk model, said original factor risk model comprising a set of factors, a matrix of factor exposures, a matrix of factor covariances, and a matrix of specific covariances;
partitioning by the programmed computer the factors of the original factor risk model into three or more groups of factors, the first three of which are a dominant first group or market factor, and a subordinate second group of industry factors, and a subordinate third group of country factors;
determining a modified factor-factor covariance matrix in which the factor covariance between the second and third groups is replaced by a new estimate that depends only on the covariances of the first, second, and third groups as defined by the original factor risk model;
determining a modified factor risk model that uses the matrix of factor exposures and matrix of specific covariances of the original factor risk model and the modified factor-factor covariance matrix; and
electronically outputting the modified factor risk model using an output device.

18. The non-transitory computer-readable medium of claim 1 where the method further comprises:
partitioning by the programmed computers the factors of the original factor risk model to include a fourth independent group of currency factors.

19. The non-transitory computer-readable medium of claim 1 where the method further comprises:
selecting a set of industry factors as either the second or third subordinate group of factors.

20. The non-transitory computer-readable medium of claim 1 where the method further comprises:
selecting a set of country factors as either the second or third subordinate group of factors.

21. The system of claim 5 where the programmed processor determines a set of industry factors as either the second or third subordinate group.

22. The system of claim 5 where the programmed processor determines a set of country factors as either the second or third subordinate group.
